(19) United States
(12) Patent Application Publication
(10) Pub. No.: US 2026/0365171 A1
(43) Pub. Date: Nov. 19, 2026

(54) MOBILE OBJECT CONTROL DEVICE, MOBILE OBJECT CONTROL METHOD, AND NON-TRANSITORY STORAGE MEDIUM

(71) Applicant: HONDA MOTOR CO., LTD., Tokyo (JP)

(72) Inventors: Fumiya Kobayashi, Tokyo (JP); Shunya Ishikawa, Tokyo (JP); Ravi Pratap Tripathi, Maharashtra (IN); Sampath Praveen Allanki, Maharashtra (IN); Yashaswini G, Maharashtra (IN)

(21) Appl. No.: 19/541,487

(22) Filed: Feb. 17, 2026

(30) Foreign Application Priority Data
Mar. 19, 2025 (JP) 2025-046036

(51) Int. Cl. B60W 30/18; B60W 30/14

(52) U.S. Cl. CPC B60W 30/18154; B60W 30/143; B60W 2554/4044

(57) ABSTRACT

A mobile object control device recognizes an object around a first mobile object, and controls the first mobile object with reference to an intersection having a higher degree of approach among degrees of approach between a first target and a second target corresponding to a plurality of intersections when the first target arrives at each of the plurality of intersections in a case in which there are the plurality of intersections due to at least one of the first mobile object and the second mobile object performing a turning operation, in which the first target is one of the first mobile object and the second mobile object, and the second target is a mobile object different from the first target among the first mobile object and the second mobile object.

### CROSS-REFERENCE TO RELATED APPLICATION

Priority is claimed on Japanese Patent Application No. 2025-046036, filed Mar. 19, 2025, the content of which is incorporated herein by reference.

### BACKGROUND

### Field of the Invention

The present invention relates to a mobile object control device, a mobile object control method, and a non-transitory storage medium.

### Description of Related Art

In recent years, research and practical application have advanced regarding automated driving, driving assistance, and the like for automatically controlling travel of a vehicle. For example, a driving assistance device that recognizes an object present around a host vehicle and determines a degree of approach between the host vehicle and an object is known (Japanese Unexamined Patent Application, First Publication No. 2024-057386).

### SUMMARY

However, in a driving assistance system of the related art, a mobile object cannot be appropriately controlled. For example, the mobile object cannot be appropriately controlled based on a predicted path of a host vehicle and a predicted path of another vehicle.

For solving the above problem, an object of the present application is to provide a mobile object control device, a mobile object control method, and a non-transitory storage medium that can appropriately control a mobile object. More specifically, an object is to appropriately control a mobile object with reference to an intersection predicted to have a higher degree of approach among a plurality of intersections between a predicted path of a host vehicle and a predicted path of another vehicle.

A mobile object control device, a mobile object control method, and a non-transitory storage medium according to the present invention adopt the following configurations.
(1) A mobile object control device according to one aspect of the present invention includes a storage medium configured to store computer-readable instructions; and one or more processors connected to the storage medium, wherein the one or more processors execute the computer-readable instructions to: recognize an object around a first mobile object; control the first mobile object with reference to an intersection between a predicted path of the first mobile object and a predicted path of a second mobile object when it is determined that the second mobile object is present around the first mobile object based on a result of the recognition; and control the first mobile object with reference to an intersection having a higher degree of approach among degrees of approach between a first target and a second target corresponding to a plurality of intersections when the first target arrives at each of the plurality of intersections in a case in which there are the plurality of intersections due to at least one of the first mobile object and the second mobile object performing a turning operation; the first target is one of the first mobile object and the second mobile object; and the second target is a mobile object different from the first target among the first mobile object and the second mobile object.
(2) In the aspect (1), the one or more processors execute the computer-readable instructions to: obtain a plurality of first arrival indices and a plurality of second arrival indices, the plurality of first arrival indices being times until the first target arrives at the respective plurality of intersections, the plurality of second arrival indices being times until the second target arrives at the respective plurality of intersections; and control the first mobile object with reference to the intersection for a smaller difference between the first arrival index and the second arrival index for each intersection.
(3) In the aspect (1), the one or more processors execute the computer-readable instructions to: obtain a plurality of first arrival indices and a plurality of second arrival indices, the plurality of first arrival indices being times when the first target is predicted to arrive at the plurality of intersections, the plurality of second arrival indices being times when the second target is predicted to arrive at the plurality of intersections; and control the first mobile object with reference to the intersection for a smaller difference between the first arrival index and the second arrival index for each intersection.
(4) In the aspect (1), the one or more processors execute the computer-readable instructions to control the first mobile object with reference to the intersection having a high degree of approach when the first mobile object is performing a turning operation.
(5) In the aspect (1), the one or more processors execute the computer-readable instructions to exclude the intersection present behind the first mobile object among the plurality of intersections from intersections for obtaining the degree of approach.
(6) In the aspect (1), the one or more processors execute the computer-readable instructions to: set two or more reference positions for one or both of the first target and the second target; obtain the degree of approach using each of the two or more reference positions when each of the plurality of reference positions arrives at each of the plurality of intersections; and control the first mobile object with reference to the intersection having a high degree of approach among a plurality of degrees of approach.
(7) In the aspect (1), the one or more processors execute the computer-readable instructions to execute control of one or more of the following controls (A) to (C) so that the degree of approach becomes lower with reference to the intersection having a high degree of approach:
(A) controlling a speed of the first mobile object,
(B) controlling steering of the first mobile object, and
(C) causing an alarm to be output to a driver of the first mobile object.
(8) A mobile object control method according to one aspect of the present invention includes: recognizing, by a computer, an object around a first mobile object; controlling, by the computer, the first mobile object with reference to an intersection between a predicted path of the first mobile object and a predicted path of a second mobile object when it is determined that the second mobile object is present around the first mobile object based on a result of the recognition; and controlling, by the computer, the first mobile object with reference to an intersection having a higher degree of approach among degrees of approach between a first target and a second target corresponding to a plurality of intersections when the first target arrives at each of the plurality of intersections in a case in which there are the plurality of intersections due to at least one of the first mobile object and the second mobile object performing a turning operation, wherein the first target is one of the first mobile object and the second mobile object, and the second target is a mobile object different from the first target among the first mobile object and the second mobile object.
(9) A non-transitory storage medium having a program stored therein according to one aspect of the present invention, the non-transitory storage medium causing a computer to: recognize an object around a first mobile object; control the first mobile object with reference to an intersection between a predicted path of the first mobile object and a predicted path of a second mobile object when it is determined that the second mobile object is present around the first mobile object based on a result of the recognition; and control the first mobile object with reference to an intersection having a higher degree of approach among degrees of approach between a first target and a second target corresponding to a plurality of intersections when the first target arrives at each of the plurality of intersections in a case in which there are the plurality of intersections due to at least one of the first mobile object and the second mobile object performing a turning operation, wherein the first target is one of the first mobile object and the second mobile object, and the second target is a mobile object different from the first target among the first mobile object and the second mobile object.

According to the aspects (1) to (9), when there are a plurality of intersections between the predicted path of the first mobile object and the predicted path of the second mobile object, it is possible to appropriately control the mobile object with reference to an appropriate intersection by deriving the degree of approach for each intersection.

According to the aspect (2) or (3), when there are a plurality of intersections between the predicted path of the first mobile object and the predicted path of the second mobile object, it is possible to appropriately control the mobile object by deriving the degree of approach based on a first index and a second index for each intersection.

According to the aspect (4), when the first mobile object is performing a turning operation which tends to cause a plurality of intersections to occur, it is possible to predict the path of the first mobile object more appropriately, and control the mobile object with reference to a more appropriate intersection.

According to the aspect (5), control is performed according to a traveling state of the mobile object by deriving a degree of approach for each of intersections other than an intersection present behind the first mobile object. Even when the degree of approach between the first mobile object and the second mobile object is high with respect to the intersection present behind the first mobile object, the first mobile object and the second mobile object are predicted to travel in directions away from each other before approaching the intersection present behind the mobile object, and therefore, more appropriate control of the mobile object is performed by excluding the intersection present behind the mobile object as described above.

According to the aspect (6), it is possible to derive appropriate intersections taking into account shapes of the mobile object by setting the plurality of reference positions. Accordingly, it is possible to improve the determination accuracy regarding the degree of approach, and perform the control of the mobile object with reference to a more appropriate intersection.

According to the aspect (7), it is possible to reduce the degree of approach at the intersection serving as a reference by performing one or more controls among (A) to (C) with reference to the derived intersection, and control according to a surrounding situation is performed.

### BRIEF DESCRIPTION OF THE DRAWINGS

FIG. 1 is a configuration diagram of a vehicle system using a mobile object control system according to an embodiment.

FIG. 2 is a diagram showing an example of a scene to which processing of the present embodiment is applied.

FIG. 3 is a diagram showing an example of values used when a reference intersection is determined.

FIG. 4 is a diagram showing an example of values used when a reference intersection is determined.

FIG. 5 is a flowchart showing an example of a flow of processing executed by a driving assistance device.

FIG. 6 is a diagram showing an example of a scene to which processing of the present embodiment is applied.

FIG. 7 is a flowchart showing an example of a flow of processing executed by the driving assistance device.

FIG. 8 is a diagram showing an example of a scene to which the processing of the present embodiment is applied.

FIG. 9 is a diagram showing an example of values used when a reference intersection is determined.

FIG. 10 is a flowchart showing an example of a flow of processing executed by a driving assistance device.

### DETAILED DESCRIPTION OF THE INVENTION

### Overall Configuration

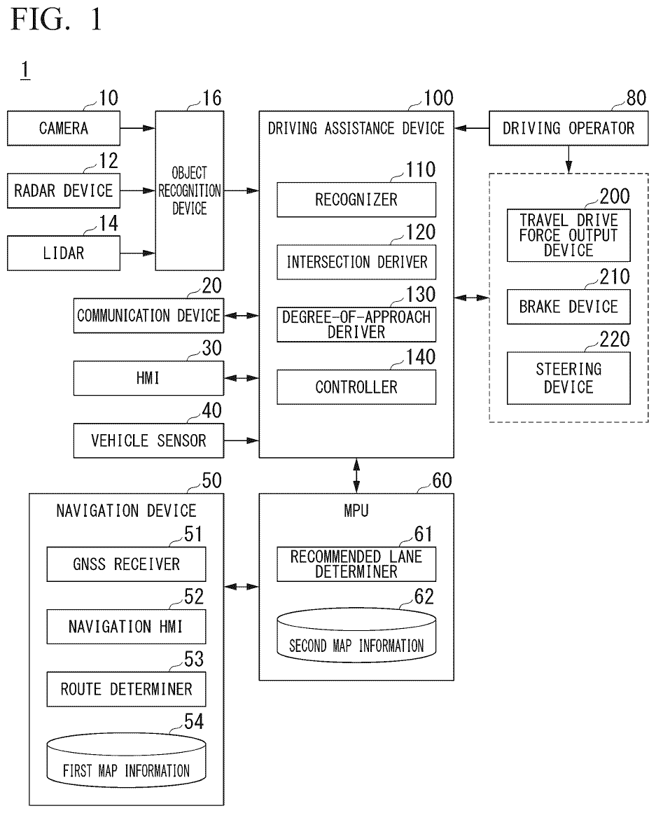

FIG. 1 is a configuration diagram of a vehicle system 1 using a mobile object control system according to an embodiment. A vehicle on which the vehicle system 1 is mounted is, for example, a two-wheeled, three-wheeled, or four-wheeled vehicle, and a driving source thereof is an internal combustion engine such as a diesel engine or a gasoline engine, an electric motor, or a combination thereof. The electric motor operates using electric power generated by a generator connected to the internal combustion engine or electric power discharged from a secondary battery or a fuel cell. The present embodiment will be described as being applied to a vehicle, but present embodiment may also be applied to other mobile object instead of a vehicle. A vehicle on which the vehicle system 1 is an example of a “first mobile object.”

The vehicle system 1 includes, for example, a camera 10, a radar device 12, a light detection and ranging (LIDAR) 14, an object recognition device 16, a communication device 20, a human machine interface (HMI) 30, vehicle sensors 40, a navigation device 50, an MPU 60, an operator 80, a driving assistance device 100, a travel drive force output device 200, a brake device 210, and a steering device 220. These devices or units are interconnected by a multiplex communication line such as a controller area network (CAN) communication line, a serial communication line, or a wireless communication network, or the like. The configuration shown in FIG. 1 is merely an example, part of the configuration may be omitted, or additional configurations may be added. The driving assistance device 100 is an example of a “mobile object control device.”

The camera 10 is, for example, a digital camera that uses a solid-state imaging element such as a charge coupled device (CCD) or a complementary metal oxide semiconductor (CMOS). The camera 10 is attached to any location of a vehicle (hereinafter referred to as the vehicle M) on which the vehicle system 1 is mounted. When imaging the front, the camera 10 is attached to, for example, an upper portion of a front windshield or a rear surface of a room mirror. The camera 10 periodically and repeatedly images surroundings of the vehicle M. The camera 10 may be a stereo camera.

The radar device 12 radiates radio waves such as millimeter waves to the surroundings of the vehicle M and detects radio waves (reflected waves) reflected by an object, thereby detecting at least a position (distance and direction) of the object. The radar device 12 may be attached at any location on the vehicle M. The radar device 12 may detect the position and speed of the object using a frequency modulated continuous wave (FM-CW) scheme.

The LiDAR 14 irradiates the surroundings of the vehicle M with light (or electromagnetic waves with a wavelength close to that of light) and measures scattered light. The LiDAR 14 detects a distance to a target based on time from light emission to light reception. The radiated light is, for example, pulsed laser light. The LiDAR 14 is attached at any position on the vehicle M.

The object recognition device 16 performs sensor fusion processing on detection results from some or all of the camera 10, the radar device 12, and the LiDAR 14 to recognize a position, type, speed, and the like of an object. The object recognition device 16 outputs a recognition result to the driving assistance device 100. The object recognition device 16 may output the detection results of the camera 10, the radar device 12, and the LiDAR 14 directly to the driving assistance device 100. The object recognition device 16 may be omitted from the vehicle system 1.

The communication device 20 uses, for example, a cellular network, a Wi-Fi network, Bluetooth (registered trademark), dedicated short range communication (DSRC), or the like to communicate with other vehicles present around the vehicle M or communicate with various server devices via a wireless base station.

The HMI 30 presents various types of information to the occupants of the vehicle M and receives input operations from the occupants. The HMI 30 includes various display devices, speakers, buzzers, touch panels, switches, keys, and the like. The HMI 30 includes a display device. The display device is, for example, a display device that is provided in a central portion of an instrument panel of the vehicle M to display various kinds of information in the vehicle M, such as a speedometer that represents a traveling speed of the vehicle M or a tachometer that represents a rotation speed (rotational speed) of an internal combustion engine included in the vehicle M, that is, a so-called multi-information display.

The vehicle sensor 40 includes a vehicle speed sensor that detects the speed of the vehicle M, an acceleration sensor that detects acceleration, a yaw rate sensor that detects angular velocity around a vertical axis, a direction sensor that detects the orientation of the vehicle M, a sensor that detects a steering rotation angle, and the like.

The navigation device 50 includes, for example, a global navigation satellite system (GNSS) receiver 51, a navigation human machine interface (HMI) 52, and a route determiner 53. The navigation device 50 stores first map information 54 in a storage device such as a hard disk drive (HDD) or a flash memory. The GNSS receiver 51 determines the position of the vehicle M based on signals received from GNSS satellites. The position of the vehicle M may also be determined or supplemented by an inertial navigation system (INS) using an output of the vehicle sensor 40. The navigation HMI 52 includes a display device, a speaker, a touch panel, keys, and the like. Part or all of the navigation HMI 52 may be shared with the HMI 30 described above. The route determiner 53, for example, determines a route (hereinafter referred to as a “map route”) from a position of the vehicle M identified by the GNSS receiver 51 (or any input position) to the destination entered by the occupant using the navigation HMI 52, with reference to the first map information 54. The first map information 54 is, for example, information in which a road geometry is represented by links indicating roads and nodes connected by the links. The first map information 54 may include, for example, road curvature or point of interest (POI) information. The map route is output to the MPU 60. The navigation device 50 may provide route guidance using the navigation HMI 52 based on the map route. The navigation device 50 may also be realized using functions of a terminal device such as a smartphone or tablet owned by the occupant. The navigation device 50 may transmit a current location and destination to a navigation server via the communication device 20 and acquire a route equivalent to the map route from the navigation server.

The MPU 60 includes, for example, a recommended lane determiner 61 and stores second map information 62 in a storage device such as an HDD or flash memory. The recommended lane determiner 61 divides the map route provided by the navigation device 50 into a plurality of blocks (for example, every 100 meters in a direction in which the vehicle travels) and determines a recommended lane for each block by referring to the second map information 62. The recommended lane determiner 61 determines, for example, which lane number from the left the vehicle travels in. When there is a branch location on the map route, the recommended lane determiner 61 determines a recommended lane that allows the vehicle M to travel on a reasonable path toward a branch destination. For example, when the vehicle M arrives at a position a predetermined distance before the branch road on which the vehicle M is to travel, the recommended lane determiner 61 determines a lane connected to the branch road to be the recommended lane. The recommended lane determiner 61 and the second map information 62 may be a functional unit or information included in other devices such as the driving assistance device 100. Information on the recommended lane is provided to the driver via the HMI, for example.

The second map information 62 is map information having higher accuracy than the first map information 54. The second map information 62 includes, for example, information on a center of a lane or information on boundaries of the lane. The second map information 62 may include road information, traffic regulation information, address information (address and postal code), facility information, telephone number information, and the like. The second map information 62 may be updated at any time by the communication device 20 communicating with another device.

The operator 80 includes, for example, a steering wheel, an accelerator pedal, a brake pedal, a shift lever, and other operators. A sensor that detects an operation amount or the presence or absence of an operation is attached to the operator 80, and a result of the detection is output to some or all of the driving assistance device 100, the travel drive force output device 200, the brake device 210, and the steering device 220. The steering wheel does not necessarily need to be annular and may be in the form of an irregularly shaped steering wheel, a joystick, buttons, or the like.

The driving assistance device 100 includes, for example, a recognizer 110, an intersection deriver 120, a degree-of-approach deriver 130, and a controller 140. The recognizer 110, the intersection deriver 120, the degree-of-approach deriver 130, and the controller 140 are realized, for example, by a hardware processor such as a central processing unit (CPU) executing a program (software). Some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by cooperation between software and hardware. The program may be stored in a storage device of the driving assistance device 100 such as an HDD or flash memory (a storage device including a non-transitory storage medium) in advance, or may be stored in a removable storage medium such as a DVD or CD-ROM and installed in the HDD or flash memory of the driving assistance device 100 by the storage medium (a non-transitory storage medium) being mounted in a drive device. A functional configuration that is a combination between the controller 140, or one or both of the intersection deriver 120 and the degree-of-approach deriver 130, and the controller 140 is an example of a “controller.”

The recognizer 110 recognizes states such as a position and speed or acceleration of the object around the vehicle M based on information input via the object recognition device 16 from the camera 10, the radar device 12, and the LiDAR 14. The position of the object is recognized, for example, as a position on an absolute coordinate system with a representative point (such as a center of gravity or drive axle center) of the vehicle M as an origin, and is used for control. The position of the object may be represented by a representative point such as a center of gravity or a corner of the object, or may be represented by a region. The “state” of the object may include acceleration or jerk of the object, or a “behavior state” (for example, whether or not the object is changing lanes or is about to change lanes).

The recognizer 110 recognizes, for example, a travel path of the vehicle M and other travel paths existing in the surroundings. The travel path is a lane in which the vehicle M is traveling (travel lane), an oncoming lane with respect to the travel lane, or the like. For example, the recognizer 110 recognizes the travel paths by comparing a pattern of road markings (for example, an arrangement of solid lines and broken lines) obtained from the second map information 62 with a pattern of road markings around the vehicle M recognized from an image captured by the camera 10. The recognizer 110 may recognize the travel paths by recognizing not only road markings but also a travel path boundary (road boundary) including road markings, shoulders, curbstones, median strips, guardrails, and the like. In this recognition, the position of the vehicle M acquired from the navigation device 50 or a processing result using an INS may be taken into consideration. The recognizer 110 recognizes a stop line, an obstacle, a red signal, a tollgate, and other road events present around the vehicle M.

The recognizer 110 recognizes a behavior of the vehicle M based on a detection result of the vehicle sensor 40. For example, when the recognizer 110 recognizes the travel path, the recognizer 110 recognizes a position or posture of the vehicle M with respect to the travel path. The recognizer 110 may recognize, for example, a deviation of a reference point of the vehicle M from the lane center and an angle formed with respect to a line connecting lane centers in the traveling direction of the vehicle M, as a relative position and posture of the vehicle M with respect to the travel path. Alternatively, the recognizer 110 may recognize, for example, a position of the reference point of the vehicle M relative to either side edge (road marking or road boundary) of the travel path, as the relative position of the vehicle M with respect to the travel path.

The intersection deriver 120 derives a predicted path of the vehicle M and the predicted path of another vehicle based on the information of the vehicle M and information of the other vehicle recognized by the recognizer 110, and derives an intersection between the predicted path of the vehicle M and the predicted path of the other vehicle. The information of the vehicle M or the information of the other vehicle is information of one or more of a yaw rate angle of the vehicle M, a rotation angle of the steering, a speed, an acceleration, a position, and the like. The predicted path may include, for example, information on a position which the vehicle M or the other vehicle will arrive at every predetermined time. The other vehicle is an example of a “second mobile object.”

The degree-of-approach deriver 130 derives a degree of approach of the vehicle M and the other vehicle to the intersection derived by the intersection deriver 120. The degree of approach indicates a degree to which a second target is approaching the intersection between the predicted path of the vehicle M and the predicted path of the other vehicle when the first target arrives at the intersection. The first target is one of the vehicle M and the other vehicle, and the second target is a vehicle different from the first target between the vehicle M and the other vehicle. The degree of approach may be, for example, a straight distance between the second target and the intersection when the first target arrives at the intersection, or may be a distance on the predicted path of the second target between the second target and the intersection when the first target arrives at the intersection. The degree of approach may be, for example, a difference between a time until the first target arrives at the intersection and a time until the second target arrives at the intersection.

The controller 140 controls all components included in the driving assistance device 100 and the vehicle system 1. The controller 140 controls, for example, steering of the vehicle M, controls a speed of the vehicle M, and controls the HMI 30 to provide information to a driver. Details of processing of the intersection deriver 120, the degree-of-approach deriver 130, and the controller 140 will be described later.

The travel drive force output device 200 outputs travel drive force (torque) for travel of the vehicle M to drive wheels. The travel drive force output device 200 includes, for example, a combination of an internal combustion engine, an electric motor, a transmission, and the like, and an ECU that controls these. The ECU controls the above configuration in accordance with information input from the driving assistance device 100 or information input from the operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor in accordance with information input from the driving assistance device 100 or the information input from the operator 80 so that brake torque according to a braking operation is output to each wheel.

The steering device 220 includes, for example, a steering ECU and an electric motor. The electric motor, for example, applies force to a rack-and-pinion mechanism to change a direction of steered wheels. The steering ECU drives the electric motor in accordance with the information input from the driving assistance device 100 or the information input from the operator 80 to change the direction of the steered wheels.

### Overview

In the present embodiment, when the recognizer 110 recognizes another vehicle around the vehicle M, the controller 140 performs control of the vehicle M with reference to an intersection between the predicted path of the vehicle M and the predicted path of the other vehicle. The controller 140 performs control of at least one of speed adjustment assistance, steering assistance, and an alarm with reference to the intersection. The speed adjustment assistance, the steering assistance, and the alarm are controls for lowering a degree of approach between the vehicle M and the other vehicle at the intersection serving as a reference or near the intersection.

The speed adjustment assistance is control for adjusting a speed of the vehicle M. The speed adjustment assistance is, for example, lowering the traveling speed of the vehicle M to delay arrival at the intersection serving as a reference for control, or raising the traveling speed of the vehicle M to advance a time of the arrival at the intersection serving as a reference for control. The speed adjustment assistance may include control for stopping travel of the vehicle M.

The steering assistance is control for assisting steering of the vehicle M. The steering assistance is, for example, control for steering so that the vehicle M travels in a direction away from the intersection. The steering assistance is, for example, control for assisting steering so that the vehicle M travels while maintaining a position at a predetermined distance or more from the other vehicle.

The alarm is an alarm that alerts a driver that the vehicle M is likely to approach the other vehicle, an alarm that alerts the driver to reduce the traveling speed of the vehicle M, or an alarm that alerts the driver so that the vehicle M travels in a direction away from the intersection or the other vehicle. The alarm may include information indicating a position of an intersection to be watched. The alarm may be, for example, image display, may be sound output, may be vibration of a steering wheel. The alarm is not limited thereto, as long as alarm is something that alerts the driver.

### Details of Processing

### Scene 1

When there are a plurality of intersections between the predicted path of the vehicle M and the predicted path of the other vehicle due to at least one of the vehicle M and the other vehicle performing a turning operation, the controller 140 performs control of the vehicle M with reference to an intersection having a higher degree of approach among degrees of approach between the first target and the second target corresponding to the plurality of intersections when the first target arrives at each of the plurality of intersections.

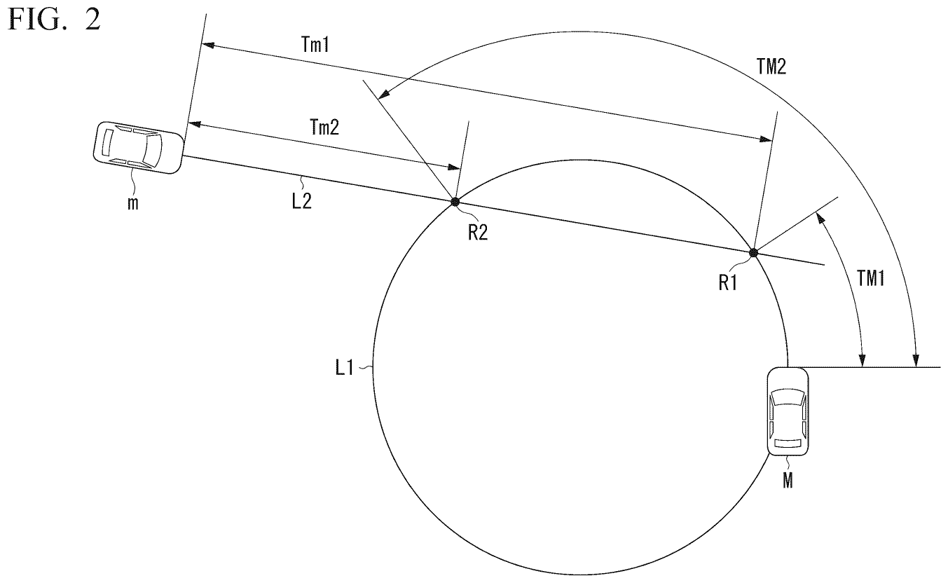

FIG. 2 is a diagram showing an exemplary scene to which processing of the present embodiment is applied. In FIG. 2, the vehicle M is performing a turning operation, and the other vehicle m is traveling straight. Intersections between the predicted path L1 of the vehicle M and the predicted path L2 of the other vehicle m are a first intersection R1 and a second intersection R2. The first target described above is the vehicle M, and the second target is the other vehicle m.

The vehicle M is performing a turning operation according to an operation of the driver. In this case, the recognizer 110 recognizes the other vehicle m around (for example, from several tens of meters to several hundreds of meters) the vehicle M. Further, the intersection deriver 120 generates the predicted path L1 of the vehicle M based on the information of the vehicle M, and generates the predicted path L2 of the other vehicle m based on the information of the other vehicle m. As a result, the positions of the first intersection R1 and the second intersection R2 are derived by the intersection deriver 120.

The predicted path L1 is a path on which a reference position of the vehicle M is predicted to travel in the future. The intersection deriver 120 generates the predicted path L1 based on a speed, a yaw rate, a steering angle, and the like of the vehicle M. When the vehicle M is performing a turning operation, for example, the intersection deriver 120 assumes a turning trajectory of the vehicle M as a predetermined circle such as a steady-state circle based on the speed, the yaw rate, the steering angle, and the like of the vehicle M. In this case, the predicted path L1 is, for example, the assumed steady-state circle. The predicted path L1 is a path derived based on a model such as a function with the yaw rate, the steering angle, and the speed of the vehicle M, a curvature of the steady-state circle obtained from these, and the like as parameters.

The predicted path L2 is a path on which a reference position of the other vehicle m is predicted to travel in the future. The intersection deriver 120 generates the predicted path L2 based on a speed, an acceleration, a position, a traveling direction, and the like of the other vehicle m.

Each of the reference positions of the vehicle M and the other vehicle m may be, for example, a front center of each vehicle, may be either of right and left ends, or may be a rear. However, the reference position is not limited thereto, and the reference position may be a position indicating a specific part arbitrarily determined in a shape of the vehicle. The reference position may be determined in advance, or may be changed during travel according to a situation of the vehicle. The reference position may be different among vehicles.

The degree-of-approach deriver 130 derives degrees of approach between the vehicle M and the other vehicle m at the first intersection R1 and the second intersection R2. The vehicle M arrives at the first intersection R1 and the second intersection R2 in this order, and the other vehicle m arrives at the second intersection R2 and the first intersection R1 in this order. The degree-of-approach deriver 130 derives an arrival time TM1 that is a time until the vehicle M arrives at the first intersection R1, and an arrival time TM2 that is a time until the vehicle M arrives at the second intersection R2, based on the predicted path L1 and a speed, an acceleration, or the like of the vehicle M. Similarly, the degree-of-approach deriver 130 derives an arrival time Tm1 that is a time until the other vehicle m arrives at the first intersection R1 and an arrival time Tm2 that is a time until the other vehicle m arrives at the second intersection R2, based on the predicted path L2 and a speed, an acceleration, or the like of the other vehicle m.

The arrival time TM1 and the arrival time TM2 are a plurality of first arrival indices. The plurality of first arrival indices are times until the vehicle M (the first target) arrives at the respective intersections. The arrival time Tm1 and the arrival time Tm2 are a plurality of second arrival indices. The plurality of second arrival indices are times until the other vehicle m (the second target) arrives at the respective intersections.

Subsequently, the degree-of-approach deriver 130 derives a margin time TTI1, which is an absolute value of a difference between the arrival time TM1 and the arrival time Tm1. The degree of approach between the vehicle M and the other vehicle m at the first intersection R1 is the margin time TTI1. The degree-of-approach deriver 130 derives a margin time TTI2, which is an absolute value of a difference between the arrival time TM2 and the arrival time Tm2. The degree of approach between the vehicle M and the other vehicle m at the second intersection R2 is the margin time TTI2. Further, the degree-of-approach deriver 130 compares the margin time TTI1 with the margin time TTI2 and sets an intersection at which a value arrives at a minimum as the reference intersection. The reference intersection is the intersection having a high degree of approach among the plurality of intersections.

The controller 140 performs control of the vehicle M with reference to the reference intersection. For example, when margin time TTI1 <margin time TTI2 (when the margin time TTI1 is smaller than the margin time TTI2), the controller 140 performs control of the vehicle M with the first intersection R1 as the reference intersection, and when margin time TTI1>margin time TTI2 (when the margin time TTI1 is larger than the margin time TTI2), the controller 140 performs control of the vehicle M with the second intersection R2 as the reference intersection. When the margin time TTI1 and the margin time TTI2 are the same, an intersection closer to the vehicle M or an intersection farther from the vehicle M may be set as the reference intersection.

Here, when the vehicle is performing a turning operation and there are a plurality of intersections, a device in which control is performed with reference to an intersection present in front of the vehicle and having a short distance to the vehicle is assumed. In this device, appropriate control is not performed due to an appropriate intersection among a plurality of intersections being not set as the reference intersection in some cases. On the other hand, in the present embodiment, as described above, when there are a plurality of intersections between the predicted path of the first mobile object and the predicted path of the second mobile object, the controller 140 can control the mobile object with reference an appropriate intersection by deriving a degree of approach for each intersection. For example, when there are two intersections between the predicted path of the vehicle M performing a turning operation and the predicted path of the other vehicle m traveling around the vehicle M, the controller 140 controls the vehicle M so that the degree of approach between the vehicle M and the other vehicle m becomes low, with reference to the intersection having a short margin time, by deriving margin times for the two intersections.

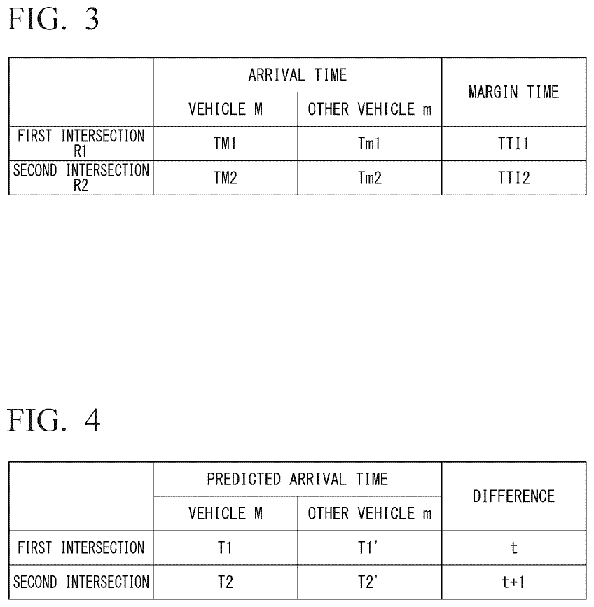

FIG. 3 is a diagram showing an example of values used when reference intersections are determined. The degree-of-approach deriver 130 derives respective arrival times of the vehicle M and the other vehicle m for the first intersection R1 and the second intersection R2. Subsequently, the degree-of-approach deriver 130 derives margin times for the first intersection R1 and the second intersection R2 based on the derived arrival times. The degree-of-approach deriver 130 compares the margin times of the first intersection R1 and the second intersection R2 and sets an intersection at which the margin time arrives at a minimum as the intersection having a high degree of approach (reference intersection). When margin time TTI1<margin time TTI2, the degree-of-approach deriver 130 sets the first intersection R1 as the reference intersection.

The degree of approach may be derived based on times when the vehicle M and the other vehicle m are predicted to arrive at the plurality of intersections. FIG. 4 is a diagram showing an example of values used when the reference intersection is determined. The degree-of-approach deriver 130 derives times when the vehicle M and the other vehicle m are predicted to arrive at the first intersection R1 and the second intersection R2, respectively. Subsequently, the degree-of-approach deriver 130 derives a difference between the predicted arrival time of the vehicle M and the predicted arrival time of the other vehicle m for the first intersection R1 and the second intersection R2 based on the respective derived predicted arrival times. The degree-of-approach deriver 130 compares the differences of the predicted arrival times and sets an intersection at which the difference between the predicted arrival times is minimized as the intersection having a high degree of approach (reference intersection). A difference (degree of approach) of predicted arrival times at the first intersection R1 is t, and a difference (degree of approach) of predicted arrival times at the second intersection R2 is t+1. In this case, since the difference between the predicted arrival times at the first intersection R1<the difference between the predicted arrival times at the second intersection R2, the degree-of-approach deriver 130 sets the first intersection R1 as the reference intersection.

Times when the vehicle M (the first target) is predicted to arrive at the respective intersections are a plurality of first arrival indices. Times when the other vehicle m (the second target) is predicted to arrive at the respective intersections are a plurality of second arrival indices.

### Flowchart 1

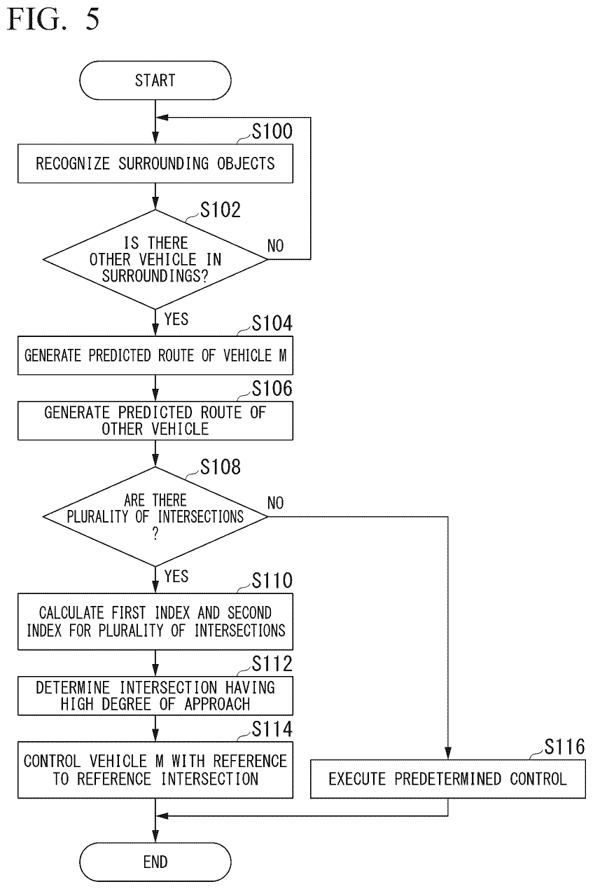

FIG. 5 is a flowchart showing an example of a flow of processing executed by the driving assistance device 100. The flowchart shown in FIG. 5 is executed, for example, when the vehicle M is traveling.

First, the recognizer 110 recognizes an object around the vehicle M (step S100). The object around the vehicle M is, for example, another vehicle. Next, the intersection deriver 120 determines whether or not another vehicle is present around the vehicle M (step S102).

When it is determined that there is no other vehicle around the vehicle M, the processing returns to step S100. When it is determined that the other vehicle is present around the vehicle M, the intersection deriver 120 generates the predicted path of the vehicle M (step S104). Next, the intersection deriver 120 generates the predicted path of the other vehicle (step S106).

Next, the intersection deriver 120 determines whether or not there are a plurality of intersections between the predicted path of the vehicle M and the predicted path of the other vehicle (step S108). When it is determined that there are no plurality of intersections, the controller 140 executes predetermined control as follows (step S116). When there are no intersections, processing of one routine of the present flowchart ends. When there is an intersection, the controller 140 controls the vehicle M with reference to the intersection.

When it is determined that there are a plurality of intersections, the degree-of-approach deriver 130 derives a first arrival index and a second arrival index for each of the plurality of intersections (step S110). Next, the degree-of-approach deriver 130 determines the intersection having a high degree of approach (reference intersection) (step S112).

After the processing of step S112, the controller 140 controls the vehicle M with reference to the reference intersection (step S114). Accordingly, the processing of the present flowchart ends.

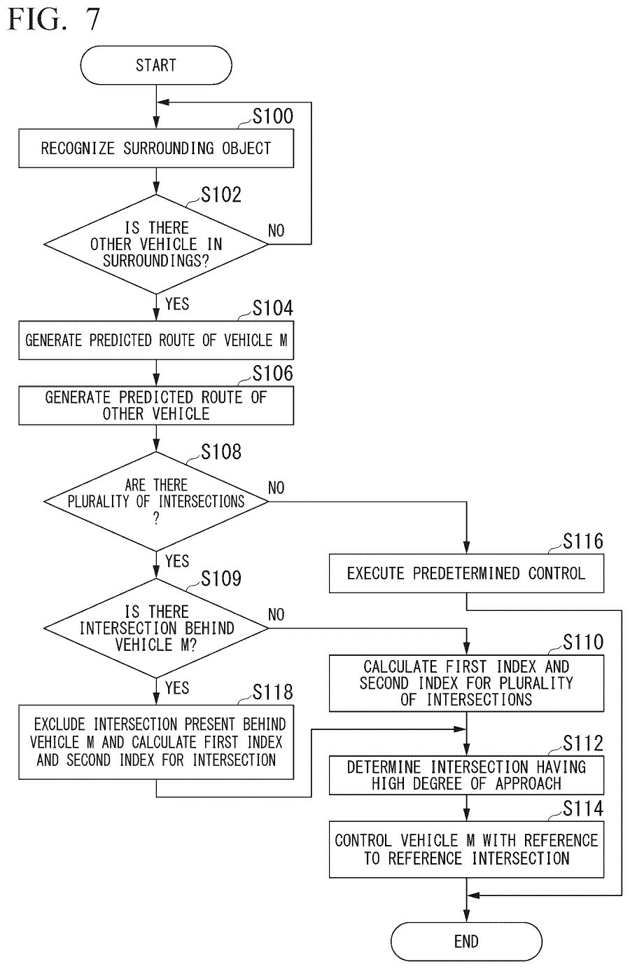

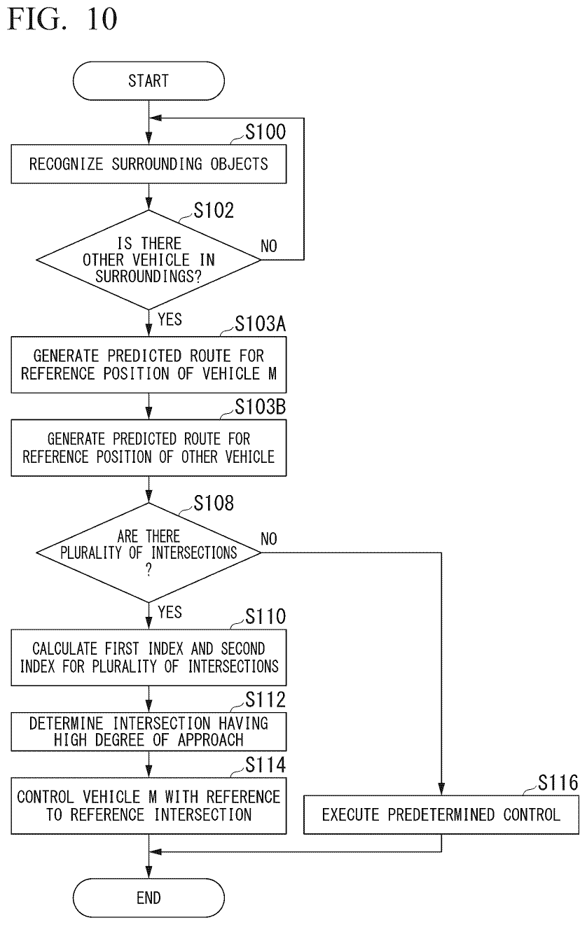

Part of the processing may be omitted, and an order of the processing may be changed. For example, the processing of S104 may be executed after the processing of S106, and when there are no intersections, the processing of step S114 may be omitted. When an arrival time or a distance to the reference intersection is equal to or greater than a threshold value, the processing of step S114 may be omitted. The same applies to FIGS. 7 and 10 to be described later. When the processing of step S114 is omitted, the vehicle M is controlled based on, for example, the vehicle speed or steering determined by a driving operation of the driver.

### Scene 2

The controller 140 excludes an intersection present behind the vehicle M among the plurality of intersections from intersections for which the degree of approach is to be obtained. Specifically, when at least one or more of the intersections between the predicted path of the vehicle M and the predicted path of the other vehicle are present behind the vehicle M, the degree-of-approach deriver 130 excludes the intersection present behind the vehicle M from the intersections for which the degree of approach is to be obtained, and determines the reference intersection from among intersections other than the intersection present behind the vehicle M.

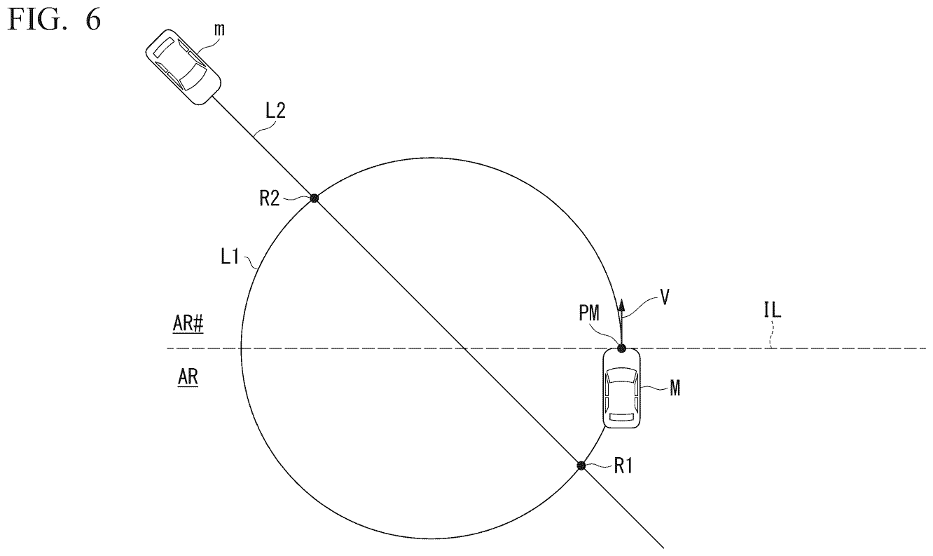

FIG. 6 is a diagram showing an exemplary scene to which the processing of the present embodiment is applied. Differences from FIG. 2 will be mainly described. In FIG. 6, the first intersection R1 is present in a rear region AR that is present behind the vehicle M.

The rear region AR is a region that is present behind the vehicle M with respect to a reference position PM that is the reference position of the vehicle M. The intersection present behind the vehicle M is, for example, an intersection behind a virtual line IL set to extend with reference to the reference position PM in a direction orthogonal to a traveling direction V with reference to the reference position PM. A region in front of the virtual line IL is a front region AR#.

When the predicted path is a path based on a predetermined circle, an intersection behind the vehicle M is an intersection present at a position at which a central angle exceeds a predetermined angle when the predicted path is assumed to be a circle in which the position of the vehicle M is assumed to be a starting point and an ending point, and the position of the vehicle M is considered as a central angle of 0 degrees. The predetermined angle is 180 degrees, an angle with reference to 180 degrees, or an angle close to 180 degrees. The predetermined angle may be determined in advance, or may be changed during travel according to a traveling state of the vehicle M or a road situation.

As in Scene 1, when the other vehicle m is recognized around the vehicle M by the recognizer 110, the positions of the first intersection R1 and the second intersection R2 are derived by the intersection deriver 120. In Scene 2, further, the degree-of-approach deriver 130 determines whether or not an intersection is present in the rear region AR.

When an intersection is present in the rear region AR, the degree-of-approach deriver 130 excludes the intersection present in the rear region AR, derives degrees of approach for intersection present in the front region AR# (intersections other than the intersection present in the rear region AR), and determines the reference intersection. For a method of deriving the degree of approach and a method of determining the reference intersection, the above-described scheme is used.

When there are no plurality of intersections in the front region AR#, the degree of approach is not derived and an intersection present in the front region AR# may be set as the reference intersection. When there are no intersections in the front region AR# and there are all intersections in the rear region AR, control of the vehicle M with reference to the intersection having a high degree of approach described above may not be performed.

When there are no intersections in the rear region AR, the degree-of-approach deriver 130 derives degrees of approach for the respective intersections to determine a reference intersection by using the scheme of Scene 1 described above.

In the example of FIG. 6, since the first intersection R1 is present in the rear region AR, the degree-of-approach deriver 130 derives degrees of approach for intersections other than the first intersection R1 and determines a reference intersection. Specifically, since an intersection other than the first intersection R1 present in the front region AR# is only one intersection, that is, the second intersection R2, the second intersection R2 is set as the reference intersection.

As described above, the degree-of-approach deriver 130 excludes the intersection present behind the vehicle M among intersections between the predicted path of the first mobile object and the predicted path of the second mobile object and derives degrees of approach for intersections other than the intersection present behind the vehicle M, thereby performing control according to a traveling state of the mobile object. For example, the first intersection R1 present in the rear region AR of the vehicle M is not taken into account when the degree of approach is derived. This is because, even when the degree of approach between the vehicle M and the other vehicle m is high with respect to the first intersection R1, the vehicle M and the other vehicle m are predicted to travel in directions away from each other before approaching the intersection present behind.

### Flowchart 2

FIG. 7 is a flowchart showing an example of a flow of processing executed by the driving assistance device 100. Differences from the processing of the flowchart of FIG. 5 will be mainly described.

The processing of steps S100 to S108 is the same as the processing of the flowchart 1 of FIG. 5 described above.

In the processing of step S108, when it is determined that there are no plurality of intersections, the controller 140 executes predetermined control as follows (step S116). When there are no intersections, processing of one routine of the present flowchart ends. When there are intersections only behind (when there are no intersections in front), similarly, the processing of one routine of the present flowchart ends. When there is an intersection in front, the controller 140 controls the vehicle M with reference to the intersection.

In the processing of step S108, when it is determined that there are a plurality of intersections, the degree-of-approach deriver 130 determines whether or not there is the intersection behind the vehicle M (step S109).

When it is determined that there is the intersection behind the vehicle M, the degree-of-approach deriver 130 excludes the intersection behind the vehicle M and derives the first arrival index and the second arrival index for the intersection (front intersection) (step S118). For example, when there are a plurality of intersections in front, the first arrival index and the second arrival index are derived for each of the plurality of intersections. For example, when there is one intersection in front, the first arrival index and the second arrival index are derived for the one intersection.

After the processing of step S118, the degree-of-approach deriver 130 determines the intersection having a high degree of approach (reference intersection) (step S112). When there is one intersection in front, the intersection becomes the reference intersection. Next, the controller 140 controls the vehicle M with reference to the reference intersection (step S114).

When it is determined in step S109 that there is no intersection behind the vehicle M, the processing proceeds to step S110. The subsequent processing is the same as the processing of the flowchart 1 of FIG. 5 described above. Accordingly, the processing of the present flowchart ends.

Whether or not there is an intersection in front (other than behind the vehicle M) is determined, and when it is determined that there are no intersections in front, the subsequent processing may be omitted. For example, when it is determined in step S108 or before step S108 that there are no intersections in front (other than behind the vehicle M), the subsequent processing may be omitted.

In the example of Scene 2, although the degree-of-approach deriver 130 has excluded the intersection present behind the vehicle M from the intersections for which the degree of approach is to be obtained, the degree-of-approach deriver 130 may not exclude the intersection present behind the vehicle M from the intersections for which the degree of approach is to be obtained when the predicted path L1 is a path based on a predetermined circle and the other vehicle m is present inside the circle (the predicted path L1). That is, when the recognizer 110 recognizes that the other vehicle m is present inside the circle of the predicted path L1 that is the predetermined circle and the intersection deriver 120 derives the intersection present in the rear region AR, the degree-of-approach deriver 130 may derive the first arrival index and the second arrival index for all of the derived intersections without excluding intersections present behind the vehicle M.

### Scene 3

The controller 140 sets two or more reference positions for one or both of the vehicle M and the other vehicle, obtains the degree of approach using each of two or more reference positions when each of the plurality of reference positions arrives at each of the plurality of intersections, and controls the vehicle M with reference to the intersection having a high degree of approach among a plurality of degrees of approach. For example, the intersection deriver 120 sets two or more reference positions for one or both of the vehicle M and the other vehicle and derives the predicted path for each of the plurality of reference positions. When there are a plurality of intersections among a plurality of predicted paths, the controller 140 performs control of the vehicle M with reference to the intersection having a high degree of approach among degrees of approach between the reference position of the vehicle M and the reference position of the other vehicle corresponding to the plurality of intersections when reference positions of the vehicles arrive at the respective plurality of intersections.

The plurality of reference positions may be set based on a shape of the vehicle such as a width and length of the vehicle, or may be set based on positions of tires. The present invention is not limited thereto, and the plurality of reference positions may be set as different positions in the vehicle.

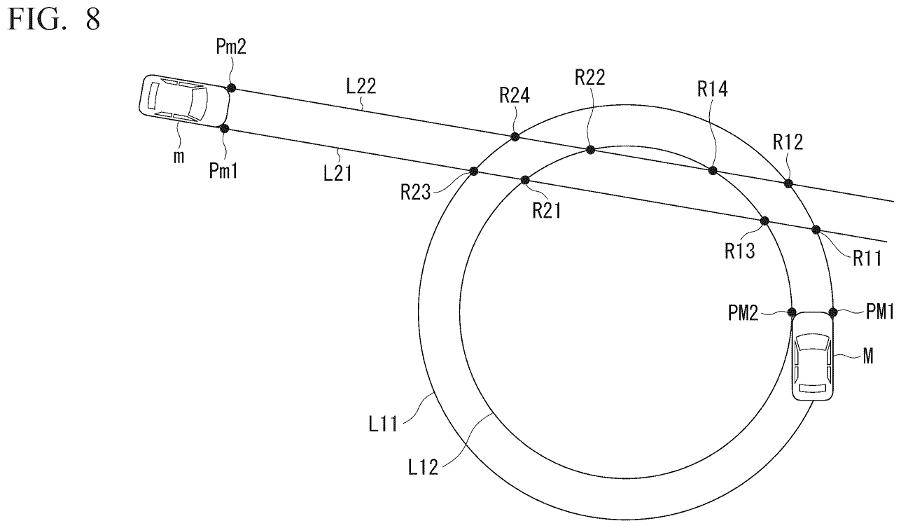

FIG. 8 is a diagram showing an exemplary scene to which the processing of the present embodiment is applied. In FIG. 8, the vehicle M performs a turning operation and the other vehicle m travels straight. Reference positions of the vehicle M are a reference position PM1 and a reference position PM2, and reference positions of the other vehicle m are a reference position Pm1 and a reference position Pm2. A predicted path L11 is a predicted path based on the reference position PM1. A predicted path L12 is a predicted path based on the reference position PM2. A predicted path L21 is a predicted path based on the reference position Pm1. A predicted path L22 is a predicted path based on the reference position Pm2.

An intersection R11 and an intersection R23 are intersections between the predicted path L11 and the predicted path L21. An intersection R12 and an intersection R24 are intersections between the predicted path L11 and the predicted path L22. An intersection R13 and an intersection R21 are intersections between the predicted path L12 and the predicted path L21. An intersection R14 and an intersection R22 are intersections between the predicted path L12 and the predicted path L22.

When the other vehicle m is recognized around the vehicle M by the recognizer 110, the intersection deriver 120 generates the predicted path L11 and the predicted path L12 based on the information of the vehicle M. The intersection deriver 120 generates the predicted path L21 and the predicted path L22 based on the information of the other vehicle m. As a result, positions of the intersections R11, R12, R13, R14, R21, R22, R23, and R24 are derived by the intersection deriver 120. Hereinafter, the intersection may be referred to as a “target intersection.”

Subsequently, the degree-of-approach deriver 130 derives degrees of approach for the respective target intersections. For a method of deriving the degree of approach, the above-described scheme is used. When there is the intersection behind the vehicle M, the intersection present behind the vehicle M may be excluded, and degrees of approach may be derived for the intersections present in front (other than behind) of the vehicle M, as in Scene 2.

After the degrees of approach at the respective target intersections are derived, the degree-of-approach deriver 130 compares the plurality of degrees of approach and determines the intersection having a high degree of approach (reference intersection). The comparison of the plurality of degrees of approach may be, for example, comparing all degrees of approach at the target intersections, and setting, as the reference intersection, an intersection at which the degree of approach becomes highest among all the intersections. The comparison of the plurality of degrees of approach may be, for example, comparing degrees of approach at the intersection R11, the intersection R12, the intersection R13, and the intersection R14, determining an intersection at which the degree of approach becomes highest among the four intersections to be an intersection corresponding to the first intersection R1 of Scene 1, comparing degrees of approach at the intersection R21, the intersection R22, the intersection R23, and the intersection R24, determining an intersection at which the degree of approach becomes highest among the four intersections to an intersection corresponding to the second intersection R2 of Scene 1, and setting, as the reference intersection, the intersection having a higher degree of approach between the first intersection R1 and the second intersection R2.

The controller 140 performs the control of the vehicle M with reference to the reference intersection determined as described above.

As described above, it is possible to derive appropriate intersections taking into account shapes of the first mobile object and the second mobile object by setting the plurality of reference positions, improve the determination accuracy regarding the degree of approach, and perform the control of the vehicle M with reference to a more appropriate intersection. For example, when two reference positions of the vehicle M and two reference positions of the other vehicle m are set, predicted paths for the respective reference positions are generated, and a total of eight intersections of the respective predicted paths are derived. Positions of the eight intersections are derived in consideration of shapes of the vehicle M and the other vehicle m. Since the control of the vehicle M is performed with reference to the intersection having a high degree of approach among the eight intersections, the control of the vehicle M for further suppressing an approach to the other vehicle is realized.

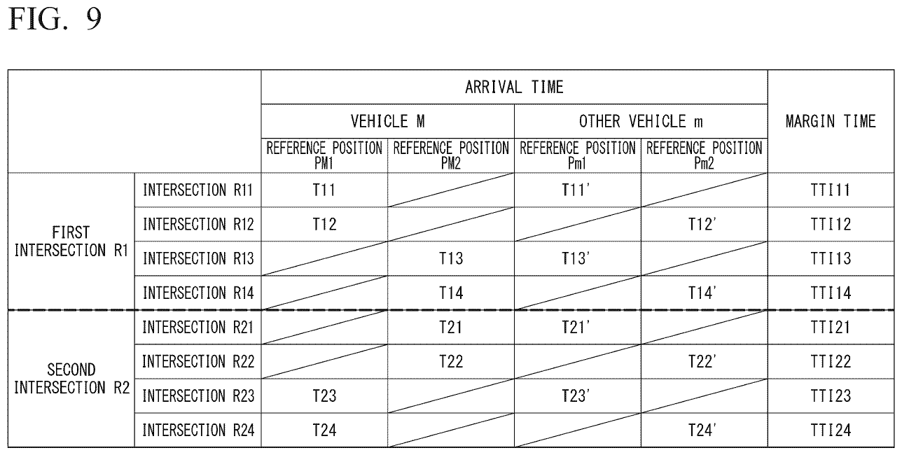

FIG. 9 is a diagram showing an example of values used when a reference intersection is determined. The degree-of-approach deriver 130 derives arrival times corresponding to the respective target intersections. Subsequently, the degree-of-approach deriver 130 derives margin times (TTI11 to TTI24 in FIG. 9) for the respective target intersections based on the derived arrival times. The degree-of-approach deriver 130 compares the margin times of the respective target intersections and determines that the intersection at which the margin time arrives at the minimum is the intersection having a high degree of approach (reference intersection).

### Flowchart 3

FIG. 10 is a flowchart showing an example of a flow of processing executed by the driving assistance device 100. Differences from the processing of the flowchart of FIG. 5 will be mainly described.

The processing of steps S100 to S102 and steps S108 to S116 is the same as the processing of the flowchart 1 of FIG. 5 described above.

After the processing of step S102 is performed, the intersection deriver 120 generates predicted paths for respective reference positions of the vehicle M (step S103A). Next, the intersection deriver 120 generates predicted paths for respective reference positions of the other vehicle (step S103B).

After the processing of step S103B is performed, the processing proceeds to step S108. The subsequent processing is the same as the processing of the flowchart 1 of FIG. 5 described above. Accordingly, the processing of the present flowchart ends. Also in the present flowchart, the intersection present behind the vehicle M may be excluded, and only the intersection present in front may be a target of control.

According to the embodiment described above, when there are a plurality of intersections between the predicted path of the first mobile object and the predicted path of the second mobile object, degrees of approach for the respective intersections are derived. Accordingly, the controller 140 can appropriately control the mobile object with reference to an appropriate intersection.

The embodiment described above can be expressed as follows.

a storage device storing a program; and

a hardware processor, and

wherein the hardware processor executes the program stored in the storage device to

recognize an object around a first mobile object,

control the first mobile object with reference to an intersection between a predicted path of the first mobile object and a predicted path of a second mobile object when it is determined that the second mobile object is present around the first mobile object, based on a result of the recognition, and

control the first mobile object with reference to an intersection having a higher degree of approach among degrees of approach between a first target and a second target corresponding to a plurality of intersections when the first target arrives at each of the plurality of intersections in a case in which there are the plurality of intersections due to at least one of the first mobile object and the second mobile object performing a turning operation,

the first target is one of the first mobile object and the second mobile object, and

the second target is a mobile object different from the first target among the first mobile object and the second mobile object.

Although embodiments for carrying out the present invention have been described above, the present invention is not limited in any way to such embodiments, and various modifications and substitutions can be made without departing from the gist of the present invention.

What is claimed is:

1. A mobile object control device comprising:
a storage medium configured to store computer-readable instructions; and
one or more processors connected to the storage medium,
wherein the one or more processors execute the computer-readable instructions to:
recognize an object around a first mobile object;
control the first mobile object with reference to an intersection between a predicted path of the first mobile object and a predicted path of a second mobile object
when it is determined that the second mobile object is present around the first mobile object based on a result of the recognition; and
control the first mobile object with reference to an intersection having a higher degree of approach among degrees of approach between a first target and a second target corresponding to a plurality of intersections
when the first target arrives at each of the plurality of intersections
in a case in which there are the plurality of intersections due to at least one of the first mobile object and the second mobile object performing a turning operation,
the first target is one of the first mobile object and the second mobile object, and
the second target is a mobile object different from the first target among the first mobile object and the second mobile object.

2. The mobile object control device according to claim 1,
wherein the one or more processors execute the computer-readable instructions to:
obtain a plurality of first arrival indices and a plurality of second arrival indices,
the plurality of first arrival indices being times until the first target arrives at the respective plurality of intersections,
the plurality of second arrival indices being times until the second target arrives at the respective plurality of intersections; and
control the first mobile object with reference to the intersection for a smaller difference between the first arrival index and the second arrival index for each intersection.

3. The mobile object control device according to claim 1,
wherein the one or more processors execute the computer-readable instructions to:
obtain a plurality of first arrival indices and a plurality of second arrival indices,
the plurality of first arrival indices being times when the first target is predicted to arrive at the plurality of intersections,
the plurality of second arrival indices being times when the second target is predicted to arrive at the plurality of intersections; and
control the first mobile object with reference to the intersection for a smaller difference between the first arrival index and the second arrival index for each intersection.

4. The mobile object control device according to claim 1, wherein the one or more processors execute the computer-readable instructions to
control the first mobile object with reference to the intersection having a high degree of approach
when the first mobile object is performing a turning operation.

5. The mobile object control device according to claim 1, wherein the one or more processors execute the computer-readable instructions to
exclude the intersection present behind the first mobile object among the plurality of intersections from intersections for obtaining the degree of approach.

6. The mobile object control device according to claim 1, wherein the one or more processors execute the computer-readable instructions to:
set two or more reference positions for one or both of the first target and the second target;
obtain the degree of approach using each of the two or more reference positions
when each of the plurality of reference positions arrives at each of the plurality of intersections; and
control the first mobile object with reference to the intersection having a high degree of approach among a plurality of degrees of approach.

7. The mobile object control device according to claim 1, wherein the one or more processors execute the computer-readable instructions to execute control of one or more of the following controls (A) to (C) so that the degree of approach becomes lower with reference to the intersection having a high degree of approach:
(A) controlling a speed of the first mobile object,
(B) controlling steering of the first mobile object, and
(C) causing an alarm to be output to a driver of the first mobile object.

8. A mobile object control method comprising:
recognizing, by a computer, an object around a first mobile object;
controlling, by the computer, the first mobile object with reference to an intersection between a predicted path of the first mobile object and a predicted path of a second mobile object when it is determined that the second mobile object is present around the first mobile object based on a result of the recognition; and
controlling, by the computer, the first mobile object with reference to an intersection having a higher degree of approach among degrees of approach between a first target and a second target corresponding to a plurality of intersections when the first target arrives at each of the plurality of intersections in a case in which there are the plurality of intersections due to at least one of the first mobile object and the second mobile object performing a turning operation,
wherein the first target is one of the first mobile object and the second mobile object, and
the second target is a mobile object different from the first target among the first mobile object and the second mobile object.

9. A non-transitory storage medium having a program stored therein, the non-transitory storage medium causing a computer to:
recognize an object around a first mobile object;
control the first mobile object with reference to an intersection between a predicted path of the first mobile object and a predicted path of a second mobile object when it is determined that the second mobile object is present around the first mobile object based on a result of the recognition; and
control the first mobile object with reference to an intersection having a higher degree of approach among degrees of approach between a first target and a second target corresponding to a plurality of intersections when the first target arrives at each of the plurality of intersections in a case in which there are the plurality of intersections due to at least one of the first mobile object and the second mobile object performing a turning operation,
wherein the first target is one of the first mobile object and the second mobile object, and
the second target is a mobile object different from the first target among the first mobile object and the second mobile object.
